(19) United States
(12) Patent Application Publication
(10) Pub. No.: US 2026/0346344 A1
(43) Pub. Date: Nov. 5, 2026

(54) ELECTRIC HAMMER DRILL

(71) Applicant: ZHEJIANG URUS TOOLS CO., LTD., JIAXING (CN)

(72) Inventors: HUA ZHANG, JIAXING (CN); XINYU ZHANG, JIAXING (CN); BOJUN ZHANG, JIAXING (CN)

(21) Appl. No.: 19/663,080

(22) Filed: Apr. 29, 2026

(30) Foreign Application Priority Data
Apr. 30, 2025 (CN) 202510562557.2

(51) Int. Cl. B23B 51/02

(52) U.S. Cl. CPC B23B 51/02; B23B 2251/14

(57) ABSTRACT

Disclosed is an electric hammer drill, pertaining to the technical field of drilling equipment. The electric hammer drill includes a first cutting body. A second cutter head is connected to one end of the first cutting body. A second cutting body is detachably connected to the other end of the first cutting body. A first shank is connected to the second cutting body. The first shank is configured for engagement with an electric drill clamping component. The electric hammer drill disclosed herein has the advantages of long service life, low cost, high drilling accuracy, and minimal damage to the periphery of drilled holes, and can be flexibly adjusted and assembled under different drilling conditions.

### TECHNICAL FIELD

The present disclosure relates to the technical field of drilling equipment, and in particular, to an electric hammer drill.

### BACKGROUND

Electric hammer drill equipment mainly includes a motor, a gearbox, a piston, a drill bit, and other components. After speed reduction via the gearbox, the motor drives the piston to perform reciprocating motion inside a cylinder so as to generate impact force. Meanwhile, the drill bit is subjected to periodic impact force while rotating, thereby achieving efficient drilling and crushing operations. The electric hammer drill equipment is commonly adopted for drilling on hard materials such as concrete and masonry. Conventional drill bits fail to meet drilling requirements for the hard materials. Accordingly, a combined drill with an alloy drill bit welded onto a drill body has emerged on the market. As shown in FIG. 1, a first alloy cutter head is arranged on a drill body for drilling into hard materials such as concrete and masonry. Correspondingly, in an existing patent technology such as patent US20240399469A1, a drill bit tool and a drill bit are disclosed. The drill bit tool defines a rotational axis and includes two tool portions, where the two tool portions are located on two sides of the rotational axis in a transverse direction. Each tool portion is provided with a rake face, a flank face, and a cutting edge formed between the rake face and the flank face. The rake face of each tool portion is ground to form a ground formed surface. The ground formed surfaces of the two rake faces are different, and at least a local height difference is thus caused in two blades. The drilling precision can be improved, and the service life of a tool is also prolonged. Meanwhile, a multi-flute drill bit such as a four-flute drill bit has emerged on the market. In an existing technology namely patent WO2023064344A1, a drill bit is disclosed, including a body. The body is provided with a first end, a second end, a rotational axis defined by the first end and the second end, and a body flute extending along the rotational axis at a helix angle. The drilling tool further includes a cutting head attached to the second end of the body. The cutting head includes a first land, a second land, and cutting head flutes. The cutting head flutes are defined between the first land and the second land. The cutting head flutes extend along the rotational axis at a helix angle. However, relatively high costs are required for the use of the existing technology, and there is room for improvement in the convenience of adjustment when the drill bit copes with different drilling conditions.

### SUMMARY

The object of the present disclosure is to provide an electric hammer drill. The electric hammer drill of the present disclosure has the advantages of long service life, low cost, high drilling accuracy, and minimal damage to the periphery of drilled holes, and can be flexibly adjusted and assembled under different drilling conditions.

To solve the foregoing technical problems, the present disclosure specifically provides the following technical solutions. An electric hammer drill includes a first cutting body. A second cutter head is connected to one end of the first cutting body. A second cutting body is detachably connected to the other end of the first cutting body. A first shank is connected to the second cutting body. The first shank is configured for engagement with an electric drill clamping component.

In contrast to the existing technology in which a first cutter head is welded to a drill body, the present disclosure adopts a split-assembled solution. Only worn parts of the second cutter head, the first cutting body, or the second cutting body need to be replaced individually, and the entire equipment does not need to be scrapped, thereby reducing the use cost. When facing different drilling objects, an assembly manner and a drill bit may be replaced optionally to realize flexible adjustment. For example, the overall electric hammer drill can be extended by adding a plurality of first cutting bodies, and it is unnecessary to equip integral electric hammer drills of various specifications and sizes, which further reduces the cost. More importantly, the split-assembled solution can guarantee the coaxiality of the entire electric hammer drill. In the existing technology in which the first cutter head is welded to the drill body, oblique drilled holes may be formed after long-term use, or the coaxiality may deteriorate, resulting in obvious damage to the periphery of the drilled holes. In contrast, the technical solutions of the present disclosure can solve the foregoing problems by reassembling or replacing local component parts once coaxiality deviation occurs.

According to an embodiment of the present disclosure, one end of the first cutting body is provided with a recessed first groove. The first groove penetrates through two side surfaces of the first cutting body. The bottom of the second cutter head is provided with a first mounting block fitting the first groove. The first mounting block and the first groove are respectively provided with corresponding first connecting holes and first connecting members fitting therewith. The first groove of the first cutting body of the present disclosure can be in plugging fit with the first mounting block, so as to realize rapid disassembly and assembly during drill bit replacement. Particularly, the drill bit replacement time is greatly shortened under special application scenarios. Moreover, the plugging manner avoids the risks of wear and corrosion existing in the conventional threaded connection. The first connecting member is adopted to ensure tight connection after plugging, and the first connecting member is of a bolt or screw structure. In addition, after the first groove is in plugging fit with the first mounting block, under the condition that a drill bit driven by a motor rotates and is subjected to periodic impact force during operation of the electric hammer drill, impact stress can be uniformly dispersed at a plugged part, thereby reducing fatigue fracture caused by stress concentration. Moreover, the overall coaxiality can be guaranteed after the plugging fit between the first groove and the first mounting block, so as to avoid drilling deviation.

All plugging connection parts of the present disclosure are subjected to carburizing and quenching treatment to improve structural strength, so that the structure after plugging can bear torque and impact.

After the first groove is in plugging fit with the first mounting block, the first connecting member is screwed into the first connecting hole. The first connecting hole is a threaded hole, thereby achieving tight connection between the first groove and the first mounting block. In such a state, connecting gaps between the second cutter head or the first cutting body and the second cutting body are not prone to blockage. In contrast, the gaps are easily blocked and jammed in a threaded connection manner in a slurry or dusty environment.

According to an embodiment of the present disclosure, a side surface of the first groove is provided with a second groove, and a bottom surface of the first groove is provided with a mounting recess. The first mounting block is provided with a protruding portion filling the second groove, and the bottom of the first mounting block is provided with a first elastic member filling the mounting recess. The fit between the second groove and the protruding portion achieves centering during plugging so as to ensure coaxial alignment synchronously during plugging. In this way, the possibility of drilling deviation during product use is reduced. Moreover, the fit between the second groove and the protruding portion provides a mounting guiding effect during assembly, which simplifies the plugging mounting process and shortens the plugging time. The first elastic member is an elastic structure, such as a metal spring or an elastic column. This member serves for centering and mounting guiding during plugging mounting, and additionally for absorbing and dissipating impact stress transmitted during use of the product. For example, part of the stress transmitted from the second cutter head to the first cutting body can be dissipated by the first elastic member, so as to prevent looseness or gaps therebetween.

According to an embodiment of the present disclosure, the first cutting body is of a revolving body structure in which the surface is surrounded by spiral flutes. An end face of the first cutting body adjacent to the second cutter head is provided with a first flat surface parallel to an axis thereof. The first flat surface is in smooth transition with the spiral flutes. The arrangement of the spiral flutes on the first cutting body ensures that chips can be discharged through the spiral flutes during drilling, thereby preventing chip accumulation from blocking the drilled holes or damaging the peripheral structure of the holes. When cooling liquid is required for drilling individual materials, the spiral flutes can guide the cooling liquid to flow in and make contact with the second cutter head for cooling. The arrangement of the first flat surface facilitates the discharge of drilling chips into the spiral flutes. More importantly, the fit between the first flat surface and the spiral flutes reduces the contact area with the walls of the drilled holes, thereby decreasing drilling friction resistance and improving drilling efficiency. In addition, during the process in which the chips are discharged from the drill bit to the spiral flutes, a discharge path of the chips is changed after passing through the first flat surface, which facilitates chip breaking and prevents overlong chips from winding around the drill bit.

According to an embodiment of the present disclosure, an end of the first cutting body adjacent to the second cutting body is provided with an assembly block. The second cutting body is provided with a third groove fitting the assembly block. Both the assembly block and the third groove are provided with the first connecting holes and the first connecting members fitting therewith.

The assembly block of the first cutting body of the present disclosure can be in plugging fit with the third groove, so as to realize disassembly and assembly of the drill body. Different lengths or quantities of the first cutting bodies can be mounted according to use requirements, thereby improving use flexibility. The first connecting member is adopted to ensure tight connection after plugging, and the first connecting member is of a bolt or screw structure. In a state where the assembly block is in plugging fit with the third groove, under the condition that a drill bit driven by a motor rotates and is subjected to periodic impact force during operation of the electric hammer drill, impact stress can be uniformly dispersed at a plugged part, thereby reducing fatigue fracture caused by stress concentration. Moreover, in the present disclosure, the overall coaxiality can be guaranteed in a state where the assembly block is in plugging fit with the third groove, so as to avoid drilling deviation.

According to an embodiment of the present disclosure, the resilient first elastic member is arranged at the bottom of the assembly block. The bottom surface of the third groove is provided with a groove cavity for accommodating the first elastic member at the bottom of the assembly block. The assembly block is in plugging connection with the third groove. Two groove surfaces of the third groove are provided with recessed grooves, and the assembly block is provided with protruding portions in plugging fit with the recessed grooves.

The recessed grooves of the third groove and the protruding portions of the assembly block achieve centering during plugging so as to ensure coaxial alignment synchronously during plugging. In this way, the possibility of drilling deviation during product use is reduced. During assembly, the fit between the recessed grooves of the third groove and the protruding portions of the assembly block provides a mounting guiding effect, which simplifies the plugging mounting process and shortens the plugging time. The first elastic member is an elastic structure, such as a metal spring or an elastic column. This member serves for centering and mounting guiding during plugging mounting, and additionally for absorbing and dissipating impact stress transmitted during use of the product.

According to an embodiment of the present disclosure, a connecting end between the second cutting body and the first shank is provided with a third cutting body. The first shank is provided with a first mounting hole for accommodating the third cutting body. A threaded connecting section connected to the first shank is arranged on the second cutting body. The second cutting body and the first shank are respectively provided with the first connecting holes and the first connecting members fitting therewith. After the second cutting body is in threaded connection with the first shank, the first connecting members further enhance the connection tightness therebetween, so as to achieve axial and circumferential limiting. This prevents separation or looseness therebetween during drilling and ensures drilling precision. The first mounting hole is provided with threads fitting the threaded connecting section. The arrangement of the third cutting body improves the application flexibility of the electric hammer drill. A diameter of the third cutting body is smaller than that of the second cutting body by one magnitude, and the quantity of drill bits to be carried is reduced. Threaded connection is adopted between the first shank and the second cutting body to achieve the coaxiality between the second cutting body and the first shank.

According to an embodiment of the present disclosure, a second shank is detachably connected to the third groove. The bottom of the second shank is provided with the assembly block. The assembly block on the second shank is provided with auxiliary threaded connecting hole bodies corresponding to the first connecting holes on the third groove, and the first connecting members are arranged therein. The resilient first elastic member is arranged at the bottom of the assembly block on the second shank. The assembly block on the second shank is in plugging connection with the third groove. The two groove surfaces of the third groove are provided with recessed grooves, and the assembly block on the second shank is provided with protruding portions in plugging fit with the recessed grooves. When the third cutting body is used, the second shank is assembled with the third groove to form an electric hammer drill with a smaller drilling size, which realizes flexible assembly and adjustment of the electric hammer drill. During drilling, pre-drilling is generally adopted. To be specific, a drill bit with a relatively small diameter is adopted for pre-drilling first, and then a drill bit with a target size is adopted for drilling. This ensures drilling accuracy, reduces damage to the hole walls of drilled holes and periphery, and achieves good chip discharge effect. The third cutting body of the present disclosure can be applied to pre-drilling operation without additionally configuring drill bits with other diameters.

According to an embodiment of the present disclosure, a first spring is arranged inside the first mounting hole. A protruding ring is arranged on a hole wall of the first mounting hole. The first spring is arranged at the bottom of the first mounting hole. The protruding ring is arranged adjacent to the first spring. The first spring can be in contact with an end of the third cutting body, thereby achieving centering effect on the third cutting body and protecting the end thereof. This prevents shaking of the end thereof and contact with the hole wall of the first mounting hole. The protruding ring can guide the first spring and the third cutting body to be located at the center of the first shank, and reduces the possibility of shaking of the first spring and the third cutting body. During operation of the electric hammer drill, stress transmitted to the third cutting body can be partially dissipated by the first spring, which helps maintain stable connection and coaxiality between the first shank and the second cutting body.

According to an embodiment of the present disclosure, a detachable first annular body is arranged outside the first shank. The first cutting body has a second spring sleeved outside. The second spring is connected to the first annular body via a second elastic member. One end of the second spring is connected to the second elastic member, and the other end is connected to a retaining ring. The retaining ring is of an annular structure, a middle portion thereof allows displacement of the first cutting body, and the retaining ring is provided with a circular connecting hole. The first annular body is provided with a threaded connecting hole. A second connecting member is arranged in the threaded connecting hole, and the second connecting member is screwed to abut against an outer wall of the first shank, so as to realize a connection relationship between the first annular body and the first shank. The first annular body may be arranged at a joint between the first shank and the second cutting body to provide external auxiliary limiting, which further improves the connection tightness between the first shank and the second cutting body. The first annular body can fit the second elastic member to provide support for the second spring. During operation of the electric hammer drill, reverse impact force is generated. The second spring absorbs partial vibration to reduce impact on arms of an operator and alleviate the fatigue. The buffering effect of the second spring fitting the second elastic member also stabilizes contact between the drill bit and a workpiece, avoiding slipping or deviation caused by severe vibration. More importantly, during continuous impact, the second spring ensures that the drill bit is always attached to a drilling target, and relieves instantaneous rigid impact between the drill bit and the drilling target, thereby relatively reducing drilling noise. The arrangement of the retaining ring ensures stable abutment of the second spring against the drilling target. The retaining ring and the second spring are connected by welding, and the circular connecting hole on the retaining ring provides a connecting position therebetween.

According to an embodiment of the present disclosure, the second elastic member is sleeved outside the first cutting body and is provided with an opening allowing movement of the first cutting body.

According to an embodiment of the present disclosure, a third cutter head or a fourth cutter head may be detachably connected to an end of the first cutting body. The second cutter head is a three-flute cutter head, the third cutter head is a four-flute cutter head, and the fourth cutter head is a two-flute cutter head. A cutting edge surface of the fourth cutter head is provided with a fourth groove. The fourth groove is provided at an inclined angle relative to a cutting surface of the fourth cutter head, so as to achieve smooth chip discharge during cutting. The fourth groove can be communicated with a side surface of the fourth cutter head. The solution for the fourth groove is applicable to the second cutter head and the third cutter head.

According to an embodiment of the present disclosure, a double-ended keyway or a single-ended keyway is provided outside the first shank, so that the electric hammer drill of the present disclosure can be adapted to various types of equipment.

Compared with the existing technology, the present disclosure has the following beneficial effects. In contrast to the existing technology in which a first cutter head is welded to a drill body, the present disclosure adopts a split-assembled solution. Only worn parts of the second cutter head, the first cutting body, or the second cutting body need to be replaced individually, and the entire equipment does not need to be scrapped, thereby reducing the use cost. When facing different drilling objects, an assembly manner and a drill bit may be replaced optionally to realize flexible adjustment. For example, the overall electric hammer drill can be extended by adding a plurality of first cutting bodies, and it is unnecessary to equip integral electric hammer drills of various specifications and sizes.

The electric hammer drill disclosed herein has the advantages of long service life, low cost, high drilling accuracy, and minimal damage to the periphery of drilled holes, and can be flexibly adjusted and assembled under different drilling conditions.

### BRIEF DESCRIPTION OF FIGURES

To more clearly illustrate embodiments of the present disclosure or the technical solutions in the existing technology, the drawings required for the description of the embodiments and the existing technology will be briefly introduced below. It is apparent that the drawings described below are merely exemplary. For those of ordinary skill in the art, other implementation drawings may be derived from the provided drawings without any creative effort.

FIG. 1 is a schematic diagram illustrating composition of a conventional drill body welded with a first cutter head.

FIG. 2 is a schematic diagram illustrating a solution for an electric hammer drill according to the present disclosure.

FIG. 3 is a schematic diagram illustrating a solution for a first cutting body according to the present disclosure.

FIG. 4 is a schematic diagram illustrating a solution for connection between a second cutting body and a second shank according to the present disclosure.

FIG. 5 is a schematic diagram illustrating an internal structure of a first shank according to the present disclosure.

FIG. 6 illustrates a second external configuration of a first shank according to the present disclosure.

FIG. 7 illustrates a third external configuration of a first shank according to the present disclosure.

FIG. 8 is a schematic diagram illustrating a solution for connection between a first cutting body and a third cutter head according to the present disclosure.

FIG. 9 is a schematic diagram illustrating a solution for connection between a first cutting body and a fourth cutter head according to the present disclosure.

FIG. 10 is a partially enlarged schematic diagram of a fourth cutter head according to the present disclosure.

FIG. 11 is a schematic diagram illustrating a solution for connection between a first cutting body and a second spring according to the present disclosure.

Reference numerals: 10: drill body; 11: first cutter head; 20: second cutter head; 21: third cutter head; 22: fourth cutter head; 23: fourth groove; 30: first connecting member; 40: first cutting body; 41: first flat surface; 42: first groove; 43: second groove; 44: first elastic member; 45: assembly block; 46: first connecting hole; 50: second cutting body; 51: first shank; 52: third groove; 53: threaded connecting section; 54: third cutting body; 55: protruding ring; 56: first spring; 57: first mounting hole; 60: second shank; 70: first annular body; 71: second connecting member; 72: second elastic member; 73: second spring; and 74: retaining ring.

### DETAILED DESCRIPTION

The technical solutions in embodiments of the present disclosure will be clearly and completely described below with reference to the accompanying drawings in the embodiments of the present disclosure. It is apparent that the described embodiments are only some embodiments of the present disclosure, but not all embodiments. All other embodiments obtained by those of ordinary skill in the art based on the disclosed embodiments without creative efforts shall fall within the protection scope of the present disclosure.

First, the concepts involved in the present disclosure will be described in conjunction with the accompanying drawings. It should be noted that the following descriptions of each concept are only intended to facilitate the understanding of the contents of the present disclosure, and do not constitute any limitation to the protection scope of the present disclosure. Meanwhile, the embodiments of the present disclosure and the features in the embodiments may be combined with each other without conflict. Hereinafter, the present disclosure will be described in detail with reference to the accompanying drawings and embodiments.

### Embodiment 1

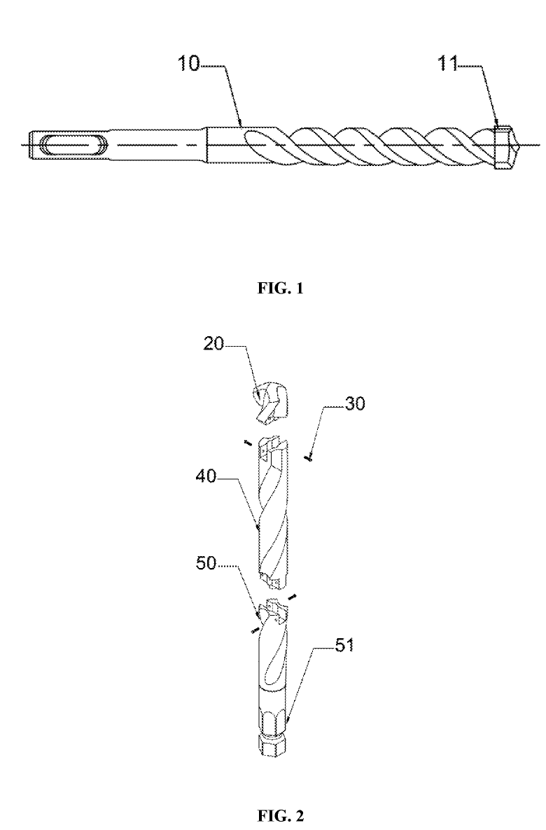

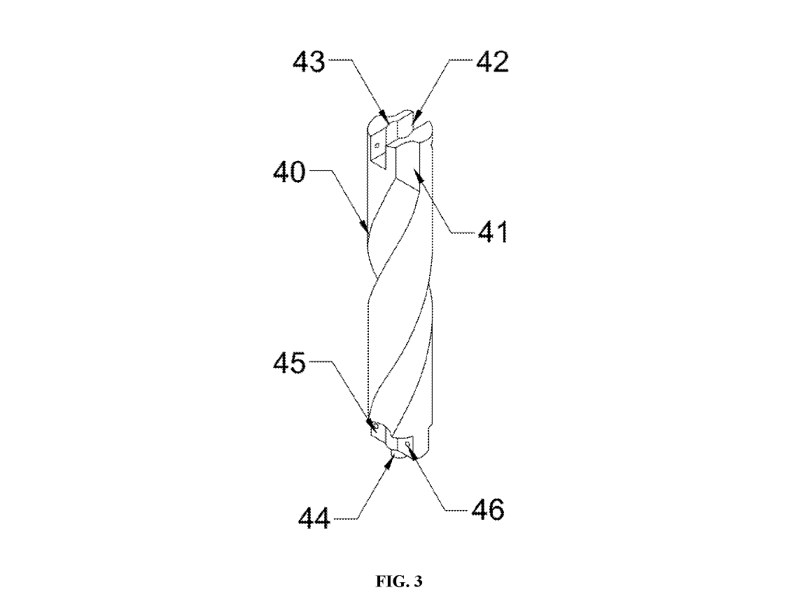

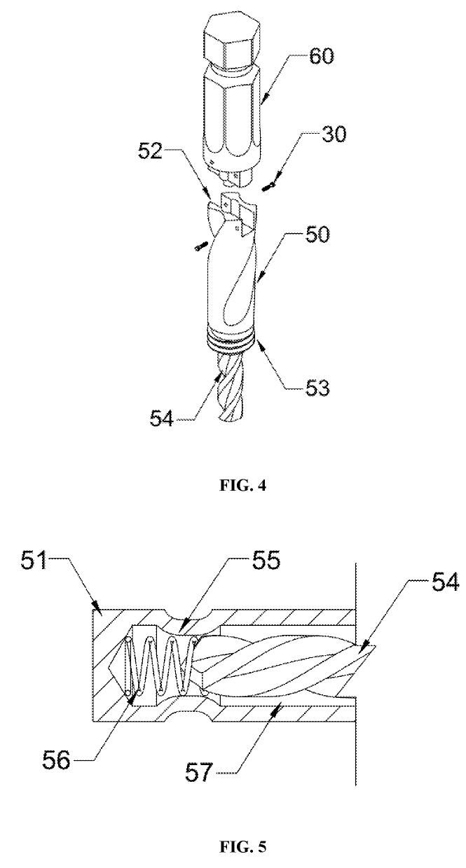

As shown in FIGS. 1 to FIG. 5, the present disclosure provides an electric hammer drill, including a first cutting body 40. A second cutter head 20 is connected to one end of the first cutting body 40. A second cutting body 50 is detachably connected to the other end of the first cutting body 40. A first shank 51 is connected to the second cutting body 50. The first shank 51 is configured for engagement with an electric drill clamping component.

In contrast to the existing technology in which a first cutter head 11 is welded to a drill body 10, the present disclosure adopts a split-assembled solution. Only worn parts of the second cutter head 20, the first cutting body 40, or the second cutting body 50 need to be replaced individually, and the entire equipment does not need to be scrapped, thereby reducing the use cost. When facing different drilling objects, an assembly manner and a drill bit may be replaced optionally to realize flexible adjustment. For example, the overall electric hammer drill can be extended by adding a plurality of first cutting bodies 40, and it is unnecessary to equip integral electric hammer drills of various specifications and sizes, which further reduces the cost. More importantly, the split-assembled solution can guarantee the coaxiality of the entire electric hammer drill. In the existing technology in which the first cutter head 11 is welded to the drill body 10, oblique drilled holes may be formed after long-term use, or the coaxiality may deteriorate, resulting in obvious damage to the periphery of the drilled holes. In contrast, the technical solutions of the present disclosure can solve the foregoing problems by reassembling or replacing local component parts once coaxiality deviation occurs.

One end of the first cutting body 40 is provided with a recessed first groove 42. The first groove 42 penetrates through two side surfaces of the first cutting body 40. The bottom of the second cutter head 20 is provided with a first mounting block fitting the first groove 42. The first mounting block and the first groove 42 are respectively provided with corresponding first connecting holes 46 and first connecting members 30 fitting therewith. The first groove 42 of the first cutting body 40 of the present disclosure can be in plugging fit with the first mounting block, so as to realize rapid disassembly and assembly during drill bit replacement. Particularly, the drill bit replacement time is greatly shortened under special application scenarios. Moreover, the plugging manner avoids the risks of wear and corrosion existing in the conventional threaded connection. The first connecting member 30 is adopted to ensure tight connection after plugging, and the first connecting member 30 is of a bolt or screw structure. In addition, after the first groove 42 is in plugging fit with the first mounting block, under the condition that a drill bit driven by a motor rotates and is subjected to periodic impact force during operation of the electric hammer drill, impact stress can be uniformly dispersed at a plugged part, thereby reducing fatigue fracture caused by stress concentration. Moreover, the overall coaxiality can be guaranteed after the plugging fit between the first groove 42 and the first mounting block, so as to avoid drilling deviation.

All plugging connection parts of the present disclosure are subjected to carburizing and quenching treatment to improve structural strength, so that the structure after plugging can bear torque and impact.

After the first groove 42 is in plugging fit with the first mounting block, the first connecting member 30 is screwed into the first connecting hole 46. The first connecting hole 46 is a threaded hole, thereby achieving tight connection between the first groove 42 and the first mounting block. In such a state, connecting gaps between the second cutter head 20 or the first cutting body 40 and the second cutting body 50 are not prone to blockage. In contrast, the gaps are easily blocked and jammed in a threaded connection manner in a slurry or dusty environment.

A side surface of the first groove 42 is provided with a second groove 43, and a bottom surface of the first groove 42 is provided with a mounting recess. The first mounting block is provided with a protruding portion filling the second groove 43, and the bottom of the first mounting block is provided with a first elastic member 44 filling the mounting recess. The fit between the second groove 43 and the protruding portion achieves centering during plugging so as to ensure coaxial alignment synchronously during plugging. In this way, the possibility of drilling deviation during product use is reduced. Moreover, the fit between the second groove 43 and the protruding portion provides a mounting guiding effect during assembly, which simplifies the plugging mounting process and shortens the plugging time. The first elastic member 44 is an elastic structure, such as a metal spring or an elastic column. This member serves for centering and mounting guiding during plugging mounting, and additionally for absorbing and dissipating impact stress transmitted during use of the product. For example, part of the stress transmitted from the second cutter head 20 to the first cutting body 40 can be dissipated by the first elastic member 44, so as to prevent looseness or gaps therebetween.

The first cutting body 40 is of a revolving body structure in which the surface is surrounded by spiral flutes. An end face of the first cutting body 40 adjacent to the second cutter head 20 is provided with a first flat surface 41 parallel to an axis thereof. The first flat surface 41 is in smooth transition with the spiral flutes. The arrangement of the spiral flutes on the first cutting body 40 ensures that chips can be discharged through the spiral flutes during drilling, thereby preventing chip accumulation from blocking the drilled holes or damaging the peripheral structure of the holes. When cooling liquid is required for drilling individual materials, the spiral flutes can guide the cooling liquid to flow in and make contact with the second cutter head 20 for cooling. The arrangement of the first flat surface 41 facilitates the discharge of drilling chips into the spiral flutes. More importantly, the fit between the first flat surface 41 and the spiral flutes reduces the contact area with the walls of the drilled holes, thereby decreasing drilling friction resistance and improving drilling efficiency. In addition, during the process in which the chips are discharged from the drill bit to the spiral flutes, a discharge path of the chips is changed after passing through the first flat surface 41, which facilitates chip breaking and prevents overlong chips from winding around the drill bit.

An end of the first cutting body 40 adjacent to the second cutting body 50 is provided with an assembly block 45. The second cutting body 50 is provided with a third groove 52 fitting the assembly block 45. Both the assembly block 45 and the third groove 52 are provided with the first connecting holes 46 and the first connecting members 30 fitting therewith.

The assembly block 45 of the first cutting body 40 of the present disclosure can be in plugging fit with the third groove 52, so as to realize disassembly and assembly of the drill body. Different lengths or quantities of the first cutting bodies 40 can be mounted according to use requirements, thereby improving use flexibility. The first connecting member 30 is adopted to ensure tight connection after plugging, and the first connecting member 30 is of a bolt or screw structure. In a state where the assembly block 45 is in plugging fit with the third groove 52, under the condition that a drill bit driven by a motor rotates and is subjected to periodic impact force during operation of the electric hammer drill, impact stress can be uniformly dispersed at a plugged part, thereby reducing fatigue fracture caused by stress concentration. Moreover, in the present disclosure, the overall coaxiality can be guaranteed in a state where the assembly block 45 is in plugging fit with the third groove 52, so as to avoid drilling deviation.

The resilient first elastic member 44 is arranged at the bottom of the assembly block 45. The bottom surface of the third groove 52 is provided with a groove cavity for accommodating the first elastic member 44 at the bottom of the assembly block 45. The assembly block 45 is in plugging connection with the third groove 52. Two groove surfaces of the third groove 52 are provided with recessed grooves, and the assembly block 45 is provided with protruding portions in plugging fit with the recessed grooves.

The recessed grooves of the third groove 52 and the protruding portions of the assembly block 45 achieve centering during plugging so as to ensure coaxial alignment synchronously during plugging. In this way, the possibility of drilling deviation during product use is reduced. During assembly, the fit between the recessed grooves of the third groove 52 and the protruding portions of the assembly block 45 provides a mounting guiding effect, which simplifies the plugging mounting process and shortens the plugging time. The first elastic member 44 is an elastic structure, such as a metal spring or an elastic column. This member serves for centering and mounting guiding during plugging mounting, and additionally for absorbing and dissipating impact stress transmitted during use of the product.

A connecting end between the second cutting body 50 and the first shank 51 is provided with a third cutting body 54. The first shank 51 is provided with a first mounting hole 57 for accommodating the third cutting body 54. A threaded connecting section 53 connected to the first shank 51 is arranged on the second cutting body 50. The second cutting body 50 and the first shank 51 are respectively provided with the first connecting holes 46 and the first connecting members 30 fitting therewith. After the second cutting body 50 is in threaded connection with the first shank 51, the first connecting members 30 further enhance the connection tightness therebetween, so as to achieve axial and circumferential limiting. This prevents separation or looseness therebetween during drilling and ensures drilling precision. The first mounting hole 57 is provided with threads fitting the threaded connecting section. The arrangement of the third cutting body 54 improves the application flexibility of the electric hammer drill. A diameter of the third cutting body 54 is smaller than that of the second cutting body 50 by one magnitude, and the quantity of drill bits to be carried is reduced. Threaded connection is adopted between the first shank 51 and the second cutting body 50 to achieve the coaxiality between the second cutting body 50 and the first shank 51.

A second shank 60 is detachably connected to the third groove 52. The bottom of the second shank 60 is provided with the assembly block 45. The assembly block 45 on the second shank 60 is provided with auxiliary threaded connecting hole bodies corresponding to the first connecting holes 46 on the third groove 52, and the first connecting members 30 are arranged therein. The resilient first elastic member 44 is arranged at the bottom of the assembly block 45 on the second shank 60. The assembly block 45 on the second shank 60 is in plugging connection with the third groove 52. The two groove surfaces of the third groove 52 are provided with recessed grooves, and the assembly block 45 on the second shank 60 is provided with protruding portions in plugging fit with the recessed grooves. When the third cutting body 54 is used, the second shank 60 is assembled with the third groove 52 to form an electric hammer drill with a smaller drilling size, which realizes flexible assembly and adjustment of the electric hammer drill. During drilling, pre-drilling is generally adopted. To be specific, a drill bit with a relatively small diameter is adopted for pre-drilling first, and then a drill bit with a target size is adopted for drilling. This ensures drilling accuracy, reduces damage to the hole walls of drilled holes and periphery, and achieves good chip discharge effect. The third cutting body 54 of the present disclosure can be applied to pre-drilling operation without additionally configuring drill bits with other diameters.

A first spring 56 is arranged inside the first mounting hole 57. A protruding ring 55 is arranged on a hole wall of the first mounting hole 57. The first spring 56 is arranged at the bottom of the first mounting hole 57. The protruding ring 55 is arranged adjacent to the first spring 56. The first spring 56 can be in contact with an end of the third cutting body 54, thereby achieving centering effect on the third cutting body 54 and protecting the end thereof. This prevents shaking of the end thereof and contact with the hole wall of the first mounting hole 57. The protruding ring 55 can guide the first spring 56 and the third cutting body 54 to be located at the center of the first shank 51, and reduces the possibility of shaking of the first spring 56 and the third cutting body 54. During operation of the electric hammer drill, stress transmitted to the third cutting body 54 can be partially dissipated by the first spring 56, which helps maintain stable connection and coaxiality between the first shank 51 and the second cutting body 50.

### Embodiment 2

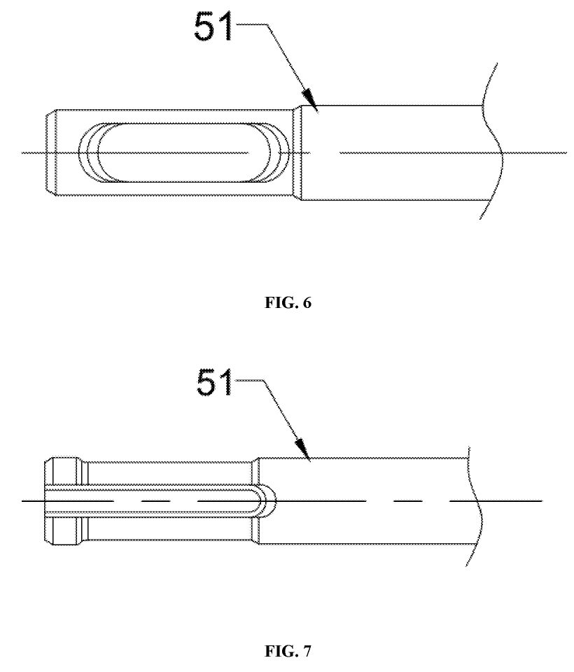

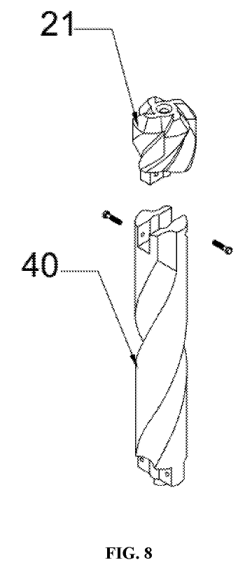

Referring to FIGS. 6 to FIG. 7, based on Embodiment 1, this embodiment further provides the following solution. A double-ended keyway or a single-ended keyway is provided outside the first shank 51, so that the electric hammer drill of the present disclosure can be adapted to various types of equipment.

### Embodiment 3

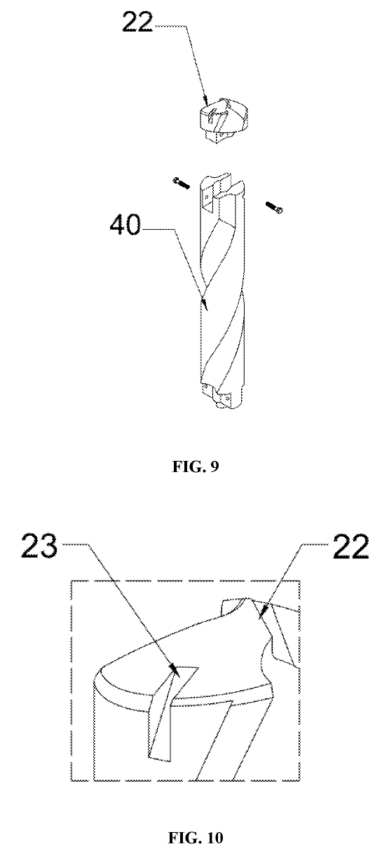

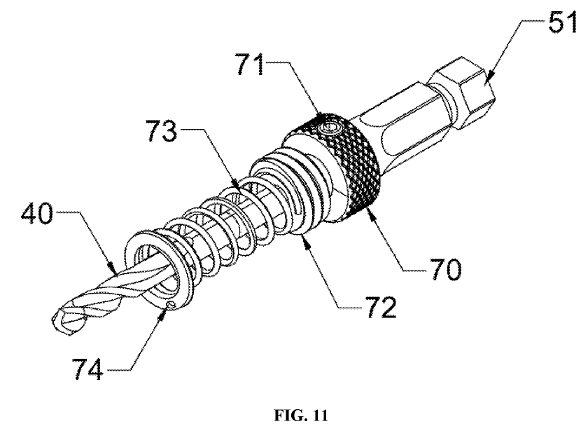

Referring to FIGS. 8 to FIG. 10, based on Embodiment 1, this embodiment further provides the following solution. A third cutter head 21 or a fourth cutter head 22 may be detachably connected to an end of the first cutting body 40. The second cutter head 20 is a three-flute cutter head, the third cutter head 21 is a four-flute cutter head, and the fourth cutter head 22 is a two-flute cutter head. A cutting edge surface of the fourth cutter head 22 is provided with a fourth groove 23. The fourth groove 23 is provided at an inclined angle relative to a cutting surface of the fourth cutter head 22, so as to achieve smooth chip discharge during cutting. The fourth groove 23 can be communicated with a side surface of the fourth cutter head 22. The solution for the fourth groove 23 is applicable to the second cutter head 20 and the third cutter head 21.

### Embodiment 4

Referring to FIG. 11, based on Embodiment 1, this embodiment further provides the following solution. A detachable first annular body 70 is arranged outside the first shank 51. The first cutting body 40 has a second spring 73 sleeved outside. The second spring 73 is connected to the first annular body 70 via a second elastic member 72. One end of the second spring 73 is connected to the second elastic member 72, and the other end is connected to a retaining ring 74. The retaining ring 74 is of an annular structure, a middle portion thereof allows displacement of the first cutting body 40, and the retaining ring 74 is provided with a circular connecting hole. The first annular body 70 is provided with a threaded connecting hole. A second connecting member 71 is arranged in the threaded connecting hole, and the second connecting member 71 is screwed to abut against an outer wall of the first shank 51, so as to realize a connection relationship between the first annular body 70 and the first shank 51. The first annular body 70 may be arranged at a joint between the first shank 51 and the second cutting body 50 to provide external auxiliary limiting, which further improves the connection tightness between the first shank 51 and the second cutting body 50. The first annular body 70 can fit the second elastic member 72 to provide support for the second spring 73. During operation of the electric hammer drill, reverse impact force is generated. The second spring 73 absorbs partial vibration to reduce impact on arms of an operator and alleviate the fatigue. The buffering effect of the second spring 73 fitting the second elastic member 72 also stabilizes contact between the drill bit and a workpiece, avoiding slipping or deviation caused by severe vibration. More importantly, during continuous impact, the second spring 73 ensures that the drill bit is always attached to a drilling target, and relieves instantaneous rigid impact between the drill bit and the drilling target, thereby relatively reducing drilling noise. The arrangement of the retaining ring 74 ensures stable abutment of the second spring 73 against the drilling target. The retaining ring 74 and the second spring 73 are connected by welding, and the circular connecting hole on the retaining ring 74 provides a connecting position therebetween.

The second elastic member 72 is sleeved outside the first cutting body 40 and is provided with an opening allowing movement of the first cutting body 40.

It should be noted that the terms used in the present disclosure are merely for the purpose of describing specific embodiments, and are not intended to limit the scope of the present disclosure. As used in the specification of the present disclosure, unless the context clearly indicates otherwise, the terms "a/an/one" and/or "the" do not exclusively refer to the singular, but may further include the plural. The terms "include", "comprise", or any other variations thereof are intended to cover non-exclusive inclusion, such that a process, method, or equipment including a series of elements includes not only those elements explicitly listed, but also other elements not explicitly recited, or elements inherent to such process, method, or equipment. Without further limitation, an element defined by the phrase "including a …" does not exclude the presence of additional identical elements in the process, method, or equipment including the element.

It should further be noted that orientation or position relationships indicated by terms such as "center", "upper", "lower", "left", "right", "vertical", "horizontal", "inner", and "outer" are based on orientation or position relationships shown in the accompanying drawings, and are merely for ease of describing the present disclosure and simplifying description, rather than indicating or implying that the mentioned device or element must have a particular orientation or must be constructed and operated in a particular orientation. Therefore, such terms should not be construed as limiting the present disclosure. Unless otherwise expressly specified and limited, the terms "mounted", "connected", and "connection" should be understood in a broad sense. For example, the connection may be a fixed connection, a detachable connection, or an integral connection. The connection may be a mechanical connection or an electrical connection. The connection may be a direct connection, or an indirect connection via an intermediate medium, or internal communication between two elements. For those of ordinary skill in the art, the specific meanings of the foregoing terms in the present disclosure may be understood according to specific situations.

The foregoing embodiments are merely preferred embodiments for implementing the technical solutions of the present disclosure, and are not intended to impose any limitation on the embodiments of the present disclosure. Any person skilled in the art may make slight modifications or alterations to equivalent embodiments without departing from the scope of technical means disclosed in the present disclosure, which shall still be regarded as technologies or embodiments substantially identical to the present disclosure.

Specific examples are used herein to elaborate the principles and embodiments of the present disclosure. The foregoing description of the embodiments is merely intended to facilitate understanding of the methods and core concepts of the present disclosure. The above is merely the preferred embodiments of the present disclosure. It should be pointed out that due to limitations of textual expression, countless specific structures objectively exist. For those skilled in the art, several improvements, refinements, or variations may be made, and the foregoing technical features may be combined in appropriate manners, without departing from the principles of the present disclosure. All such improvements, refinements, variations, combinations, or direct application of the concepts and technical solutions of the present disclosure to other occasions without modification shall fall within the protection scope of the present disclosure.

What is claimed is:

1. An electric hammer drill, comprising a first cutting body (40), wherein a second cutter head (20) is connected to one end of the first cutting body (40), a second cutting body (50) is detachably connected to the other end of the first cutting body (40), and a first shank (51) is connected to the second cutting body (50);
one end of the first cutting body (40) is provided with a recessed first groove (42), the first groove (42) penetrates through two side surfaces of the first cutting body (40), the bottom of the second cutter head (20) is provided with a first mounting block fitting the first groove (42), and the first mounting block and the first groove (42) are respectively provided with corresponding first connecting holes (46) and first connecting members (30) fitting therewith;
a side surface of the first groove (42) is provided with a second groove (43), a bottom surface of the first groove (42) is provided with a mounting recess, the first mounting block is provided with a protruding portion filling the second groove (43), and the bottom of the first mounting block is provided with a first elastic member (44) filling the mounting recess;
the first cutting body (40) is of a revolving body structure in which the surface is surrounded by spiral flutes, and an end face of the first cutting body (40) adjacent to the second cutter head (20) is provided with a first flat surface (41) parallel to an axis thereof;
a detachable first annular body (70) is arranged outside the first shank (51), the first cutting body (40) has a second spring (73) sleeved outside, the second spring (73) is connected to the first annular body (70) via a second elastic member (72), one end of the second spring (73) is connected to the second elastic member (72), the other end is connected to a retaining ring (74), the retaining ring (74) is of an annular structure, a middle portion thereof allows displacement of the first cutting body (40), and the retaining ring (74) is provided with a circular connecting hole;
the first annular body (70) is provided with a threaded connecting hole, a second connecting member (71) is arranged in the threaded connecting hole, and the second connecting member (71) is screwed to abut against an outer wall of the first shank (51); and
an end of the first cutting body (40) adjacent to the second cutting body (50) is provided with an assembly block (45), and the resilient first elastic member (44) is arranged at the bottom of the assembly block (45).

2. The electric hammer drill according to claim 1, wherein the second cutting body (50) is provided with a third groove (52) fitting the assembly block (45), and both the assembly block (45) and the third groove (52) are provided with the first connecting holes (46) and the first connecting members (30).

3. The electric hammer drill according to claim 2, wherein the bottom surface of the third groove (52) is provided with a groove cavity for accommodating the first elastic member (44) at the bottom of the assembly block (45).

4. The electric hammer drill according to claim 1, wherein a connecting end between the second cutting body (50) and the first shank (51) is provided with a third cutting body (54), the first shank (51) is provided with a first mounting hole (57) for accommodating the third cutting body (54), and a threaded connecting section (53) connected to the first shank (51) is arranged on the second cutting body (50).

5. The electric hammer drill according to claim 4, wherein a first spring (56) is arranged inside the first mounting hole (57), and a protruding ring (55) is arranged on a hole wall of the first mounting hole (57).

6. The electric hammer drill according to claim 1, wherein the second elastic member (72) is sleeved outside the first cutting body (40) and is provided with an opening allowing movement of the first cutting body (40).
